(19) United States
(12) Patent Application Publication
(10) Pub. No.: US 2013/0254516 A1
(43) Pub. Date: Sep. 26, 2013

(54) ARITHMETIC PROCESSING UNIT

(71) Applicant: FUJITSU LIMITED, Kawasaki-shi (JP)

(72) Inventors: Yi GE, Kawasaki (JP); Kazuo HORIO, Kawasaki (JP)

(21) Appl. No.: 13/670,867

(22) Filed: Nov. 7, 2012

(30) Foreign Application Priority Data
Mar. 22, 2012 (JP) 2012-066430

(51) Int. Cl. G06F 9/302

(52) U.S. Cl. 712/221; 712/E09.017

(57) ABSTRACT

An arithmetic processing unit that performs processing of a stream-type includes an arithmetic unit configured to operate an input operand to obtain a result of operation; and a data input and output unit configured to read the input operand out of a memory when an instruction which is issued in a case where a stream length of the input operand is shorter than a stream length of an output operand corresponding to the input operand and includes data indicating a recursive rule used when the input operand is read out, to supply the read input operand, and to store the result of the operation obtained by the arithmetic unit in the memory as the output operand, wherein the arithmetic unit 20 operates the input operand read out by the data input and output unit and outputs the result of operation to the data input and output unit.

### CROSS-REFERENCE TO RELATED APPLICATION

This patent application is based upon and claims the benefit of priority of the prior Japanese Patent Application No. 2012-066430 filed on Mar. 22, 2012, the entire contents of which are incorporated herein by reference.

### FIELD

The embodiments discussed herein are related to an arithmetic processing unit performing stream-type processing.

### BACKGROUND

A great number of matrix operations may be performed in baseband processing for radio communication. In order for a great amount of data to undergo the same matrix operation, a series of data is continuously read out of a memory, and a series of results of the matrix operations is stored in contiguous addresses of the memory. Such an arithmetic processing unit performing stream-type processing is preferably used.

Such instructions input to the arithmetic processing unit performing stream-type processing include an operational type, an address (a source) of storing an input operand (a source), a storage destination (a destination) of an output operand, and the number (a stream length or a vector length) of unit of data to be processed. The arithmetic processing unit continuously performs stream-type processing corresponding to the stream length. For example, there is a vector unit performing this kind of operation. For example, see J. L. Hennessy, D. A. Patterson, “Computer Architecture: A Quantitative Approach: Appendix G Vector Processors, 3rd Edition,” 2003.

### SUMMARY

According to an aspect of the embodiment, an arithmetic processing unit that performs processing of a stream-type includes an arithmetic unit configured to operate an input operand to obtain a result of operation; and a data input and output unit configured to read the input operand out of a memory when an instruction which is issued in a case where a stream length of the input operand is shorter than a stream length of an output operand corresponding to the input operand and includes data indicating a recursive rule used when the input operand is read out, to supply the read input operand, and to store the result of the operation obtained by the arithmetic unit in the memory as the output operand, wherein the arithmetic unit operates the input operand read out by the data input and output unit and outputs the result of operation to the data input and output unit.

The object and advantages of the invention will be realized and attained by means of the elements and combinations particularly pointed out in the appended claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block chart illustrating an example in which an arithmetic processing unit is applied to baseband processing LSI100 for a portable phone;

FIG. 2 illustrates an exemplary hardware structure of an arithmetic processing unit of the embodiment;

FIG. 3 illustrates an example hardware structure of an arithmetic data path when the arithmetic data path performs a matrix operation;

FIG. 4 illustrates an internal structural example of a DMA controller;

FIG. 5 illustrates basic stream-type processing performed by the arithmetic processing unit of the embodiment;

FIG. 6 illustrates processing including a wrap around performed by the arithmetic processing unit of the embodiment;

FIG. 7 illustrates processing in a residual mode (wm_src0=1) performed by the arithmetic processing unit of the embodiment;

FIG. 8 illustrates processing in a quotient mode (wm_src0=2) performed by the arithmetic processing unit of the embodiment; and

FIG. 9 illustrates processing in a quotient mode (wm_src0=2) and a residual mode (wm_src1=1) performed by the arithmetic processing unit of the embodiment.

### DESCRIPTION OF EMBODIMENTS

As described previously, the exemplary arithmetic processing unit continuously performs stream-type processing corresponding to the stream length. However, the input operand and the output operand have the same stream length. Therefore, the exemplary arithmetic processing unit does not repeatedly use one of input operands within one instruction. In order to repeatedly use one of input operands, an instruction is divided into plural instructions. For example, when a matrix operation is performed, the scale of a data path inside the arithmetic processing unit is large. Therefore, there is a problem that a considerable time is used to change over the data paths to thereby drastically lower an arithmetic performance.

Preferred embodiments of the present invention are explained next with reference to accompanying drawings.

### Embodiment

An arithmetic processing unit 1 of the embodiment is described next.

### [Exemplary Application]

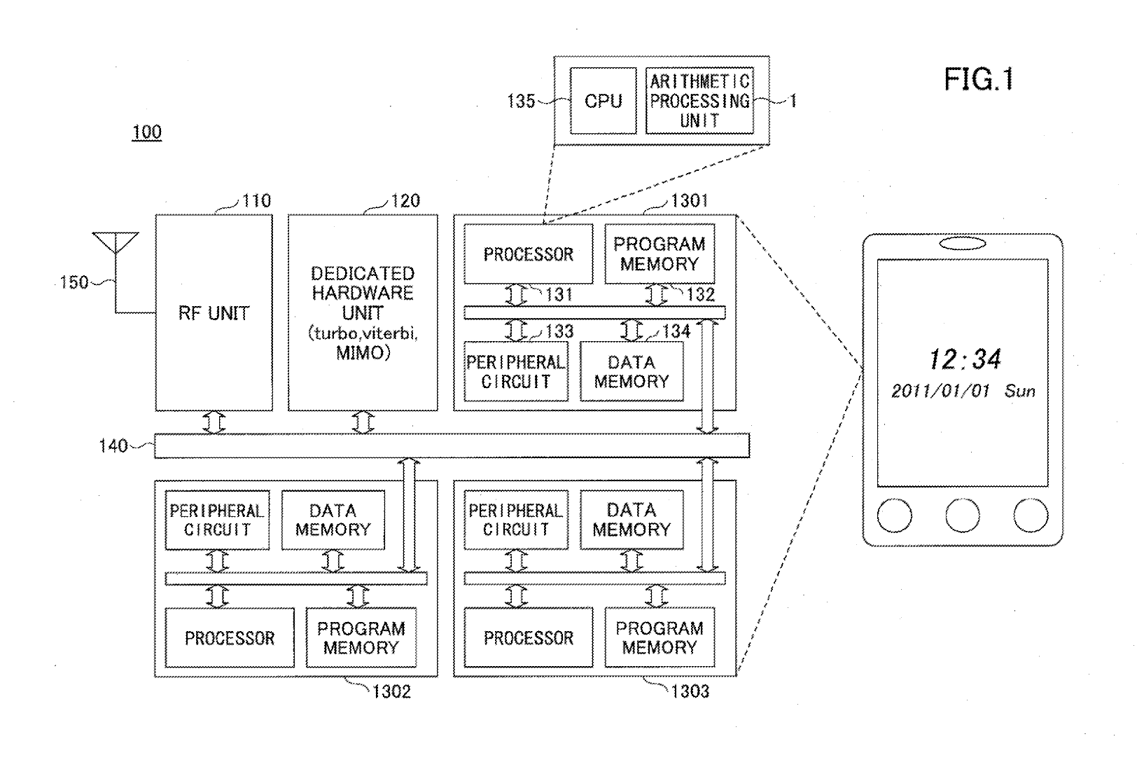

FIG. 1 is a block chart illustrating an example in which an arithmetic processing unit is applied to a baseband processing large scale integrated circuit (LSI) 100 for a portable phone. The baseband processing LSI 100 includes a RF unit 110, a dedicated hardware unit 120, and digital signal processors (DSP) 1301 to 1303.

The RF unit 110 down-converts the frequency of a radio signal received by an antenna 150 and converts the down-converted radio signal to a digital signal, outputs the converted digital signal to a bus 140. The RF unit 110 converts a digital signal output to the bus 140 to an analog signal, up-converts the converted analog signal to a radio frequency, and outputs the up-converted radio frequency to the antenna 150.

For example, a dedicated hardware unit 120 includes “turbo”, “viterbi”, Multi Input Multi Output (MIMO), and so on. The “turbo” handles an error-correcting code, the “viterbi” executes a Viterbi algorithm, and the MIMO transmits and receives data by plural antennas.

Hereinafter, the DSPs 1301 to 1303 are inclusively referred to as a DSP 130. The DSP 130 includes a processor 131, a program memory 132, a peripheral circuit 133, and a data memory 134. The processor 131 includes a CPU 135 and the arithmetic processing unit 1 of the embodiment. Various radio communication signal processes such as Searcher (synchronization), Demodulator (demodulation), Decoder (decoding), Codec (encoding) or Modulator (modulation) are performed in the DSP 130.

### [Arithmetic Processing Unit]

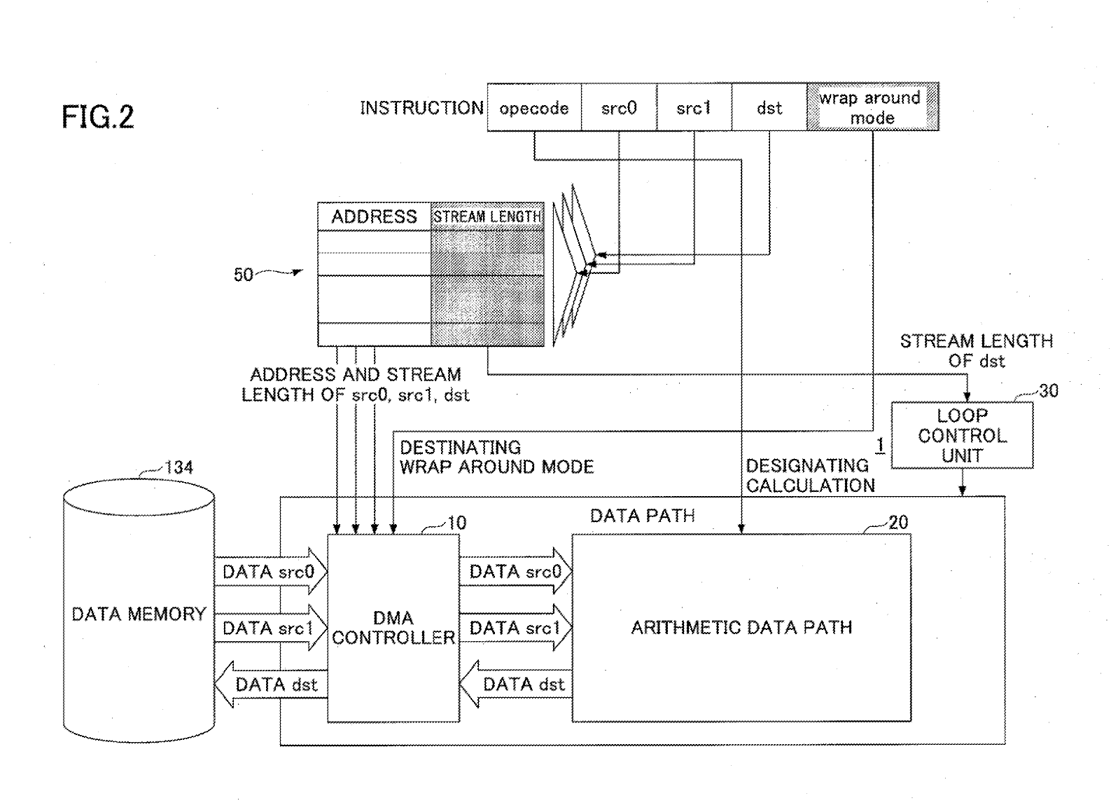

FIG. 2 illustrates an exemplary hardware structure of an arithmetic processing unit of the embodiment. The arithmetic processing unit 1 includes a Direct Memory Access (DMA) controller 10, an arithmetic data path 20, and a loop control unit 30 for controlling the number of operations.

The DMA controller 10 reads out sources (input operands) from the data memory 134 and stores the result of the operations for the sources with the arithmetic data path 20 in a storage destination (destination) of the data memory 134 as an output operand.

An instruction given to the DMA controller 10 is issued by, for example, the CPU 135. The instruction issued by the CPU 135 includes, for example, “opecode”, “src0”, “src1”, “dst” and “wrap around mode”. The “opecode” is used to indicate an instruction type, the “src0” is used to designate source (0) of the sources, the “src1” is used to designate source (1) of the sources other than the source (0), the “dst” is used to designate the destination, and the “wrap around mode”. The wrap around mode designates whether the wrap around operation is performed and an operation mode of the wrap around. The wrap around mode is set for each of the source (0), the source (1) and the destination. The wrap around mode is designated by three kinds for the source (0), namely wm_src0=0 (without the wrap around), wm_src0=1(residual mode), and wm_src0=2(quotient mode). In a manner similar to the source (0), the wrap around mode is designated by three kinds for the source (1) and the destination. When “without wrap around mode” is designated, the stream lengths of the source (0), the source (1) and the destination are equal. Operation results are the same if the residual mode is designated. Therefore, the wrap around mode may be designated by two kinds of wm_src0=1 (residual mode) or wm_src0=2 (quotient mode).

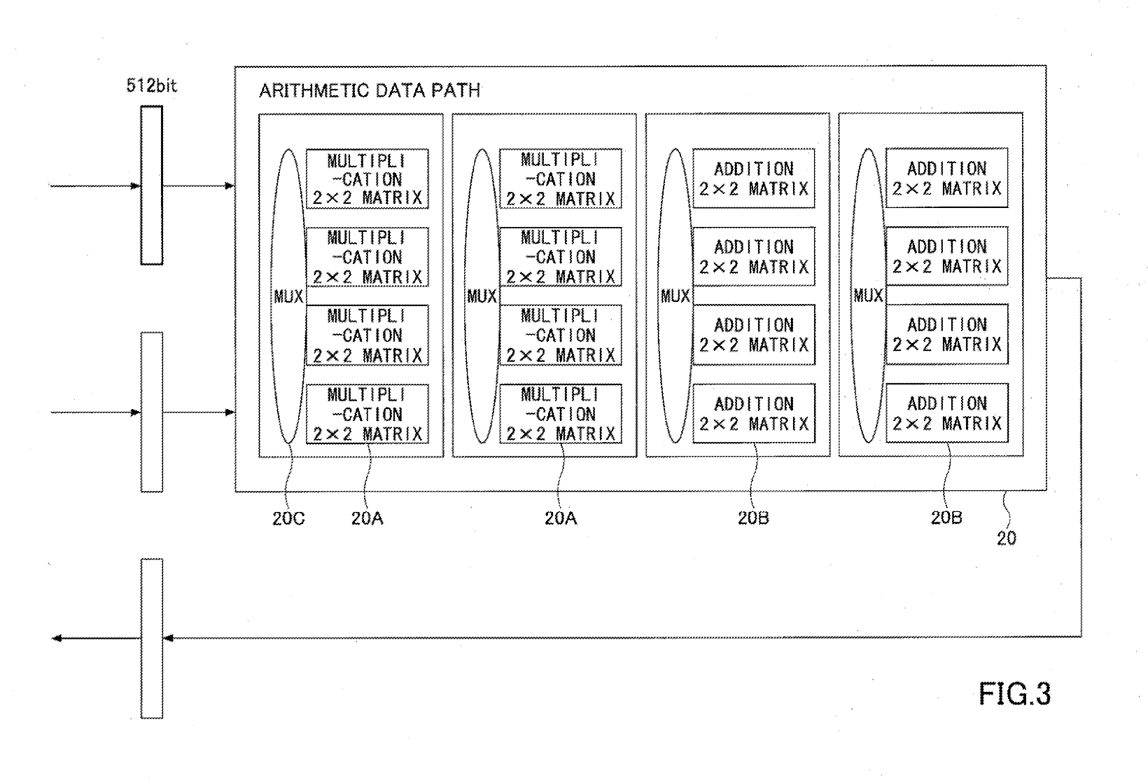

The opecode which is one of the instructions issued by the CPU 135 is input in the arithmetic data path 20. The arithmetic data path 20 can perform various operations by switching internal connections of a control circuit (not illustrated). FIG. 3 illustrates an exemplary hardware structure of the arithmetic data path 20 when the arithmetic data path 20 performs a matrix operation. For example, the arithmetic data path 20 includes eight multiplier modules (2×2 matrix) 20A and eight adder modules (2×2 matrix) 20B. One multiplexer 20C is attached to a group of four multiplier or adder modules. The arithmetic data path 20 can perform multiplication (4×4 matrix), single instruction, multiple data stream (SIMD) 4-parallel multiplication (2×2 matrix), SIMD 4-parallel multiplication (2×2 inverse matrix), or the like.

The src0 for designating the source (0), the src1 for designating the source (1), and the dst for designating the destination are input in an address register file 50. For example, the source (0) and the source (1) are two data sources to be operated. The third source and the subsequent sources may be designated.

Plural data arrays selected by the src0, the src1 and the dst are stored in the address register file 50. The data arrays include sets of the address of storing the source in the data memory 134 and the stream length or sets of the destination address and the stream length. When the src0 or the src1 is input in the address register file 50, the address register file 50 outputs the address of storing the source and the stream length of the source stored in the address to the DMA controller 10. When the dst is input in the address register file 50, the address register file 50 outputs the destination address and the stream length of data to be stored in the address to the DMA controller 10. Further, when the dst is input in the address register file 50, the address register file 50 outputs the stream length of data to be stored in the destination address to the loop control unit 30.

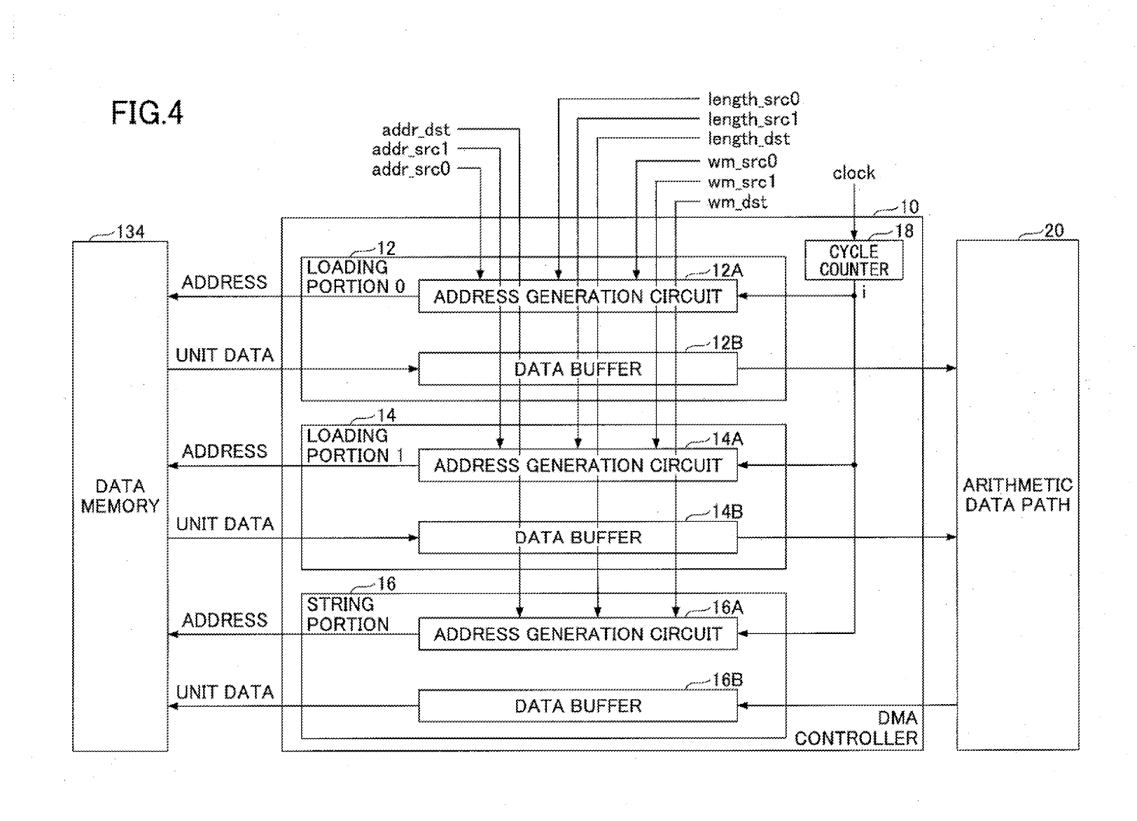

FIG. 4 illustrates an internal structural example of a DMA controller. Referring to FIG. 4, addr_src0 designates an address in which the source (0) is stored, and addr_dst designates a destination address in which the source (1) is stored. Further, length_src0 designates the stream length of the source (0), length_src1 designates the stream length of the source (1), and length_dst designates the stream length of the destination. Further, wm_src0 designates a wrap around mode for the source (0), and wm_dst designates a wrap around mode for the destination.

The DMA controller 10 includes a loading portion 12 for reading out the source (0), a loading portion 14 for reading out the source (1), a storing portion 16 for writing data to the destination, and a cycle counter 18. For example, the cycle counter 18 outputs a value i, which is incremented by one from 0 to N (N=“length_dst”−1) for each cycle while the stream-type processing is performed once, to the loading portion 12, the loading portion 14, and the storing portion 16.

The loading portion 12 includes an address generation circuit 12A and a data buffer 12B. The address generation circuit 12A receives addr_src0, length_src0, and wm_src0. In a case where wm_src0=0 (without wrap around), the address generation circuit 12A reads out one unit of data for each cycle from an address of the data memory 134 which is designated by addr_src0. The address generation circuit 12A further stores the read unit of data in the data buffer 12B. The unit of data are formed so as to be operated by the arithmetic data path 20. The unit of data includes a matrix, a number and so on. Processes in a case where wm_src0=1 (residual mode) or wm_src0=2 (quotient mode) are described later. The data stored in the data buffer 12B is output to the arithmetic data path 20 when necessary. The output data are subsequently operated.

In a manner similar to the above, the loading portion 14 includes an address generation circuit 14A and a data buffer 14B. The address generation circuit 14A receives addr_src1, length_src1, and wm_src1. In a case where wm_src1=0 (without wrap around), the address generation circuit 14A reads out one unit of data for each cycle from an address of the data memory 134 which is designated by addr_src1. The address generation circuit 12A further stores the read unit of data in the data buffer 14B. Processes in a case where wm_src1=1 (residual mode) or wm_src1=2 (quotient mode) are described later. The data stored in the data buffer 14B is output to the arithmetic data path 20 when necessary. The output data are subsequently operated.

The storing portion 16 includes an address generation circuit 16A and a data buffer 16B. The address generation circuit 16A receives addr_dst, length_dst, and wm_dst. In a case where wm_dst=0 (without wrap around), the address generation circuit 16A writes one of the unit of data stored in the data buffer 16B for each cycle in an address of the data memory 134 designated by addr_dst. Processes in a case where wm_dst=1 (residual mode) or wm_dst=2 (quotient mode) are described later. The data buffer 16B stores a result of operation in the arithmetic data path 20.

Stream-type processing performed by the arithmetic processing unit 1 of the embodiment is described next. Instructions given to the arithmetic processing unit 1 includes opecode=mul (multiplication), addr_src0=a, length_src0=100, wm_src0=0, addr_src1=b, length_src1=100, wm_src1=0, addr_dst=c, length_dst=1000, and wm_dst=0. In this case, because wm_src0=wm_src1=wm_dst=0, the arithmetic processing unit 1 does not perform wrap around for any one of the source (0), the source (1), and the destination.

### [Stream-Type Processing (Basic)]

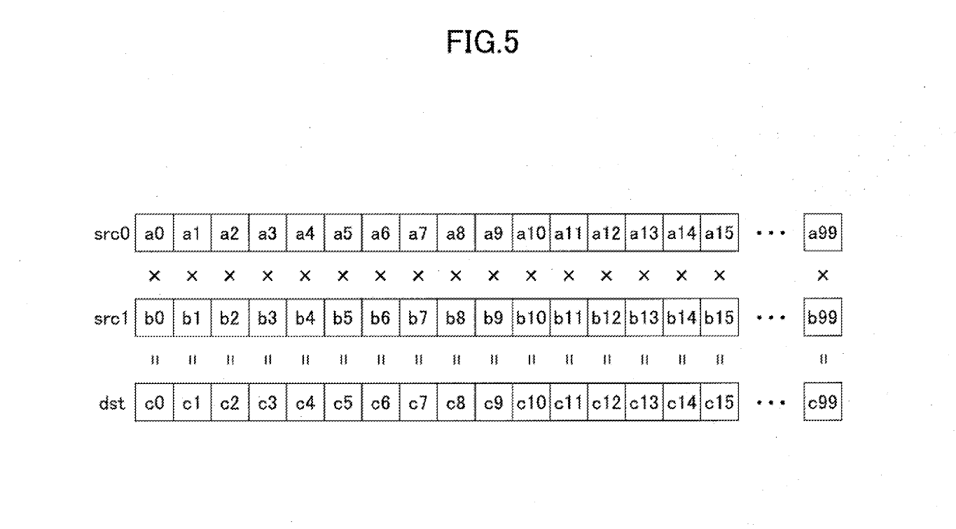

FIG. 5 illustrates basic stream-type processing performed by the arithmetic processing unit 1 of the embodiment.

The loading portion 12 reads out one unit of data for each cycle from the address a of the data memory 134 which is designated by addr_src0. The loading portion 12 reads 100 pieces of the unit of data (a0 to a99) and stores the read unit of data in the data buffer 12B. The loading portion 14 reads out one unit of data for each cycle from the address b of the data memory 134 which is designated by addr_src1. The loading portion 14 reads 100 pieces of the unit of data (b0 to b99) and stores the read unit of data in the data buffer 14B.

Meanwhile, the arithmetic data path 20 fetches data one unit of data from the unit of data stored in the data buffer 12B and one unit of data from the unit of data stored in the data buffer 14B each cycle. The fetched two unit of data are multiplied and the results of the operation are stored in the data buffer 16B. The number of operations performed by the arithmetic data path 20 is controlled by the loop control unit 30. For example, the loop control unit 30 includes a cycle counter and a sequencer. Referring to FIG. 5, c0 to c99 are unit of data stored in the data buffer 16B each cycle.

Thus, the arithmetic processing unit 1 of the embodiment can perform operations corresponding to the stream length and store the results of the operations in the data memory 134. The above processing is called “stream-type processing”.

### [Wrap Around]

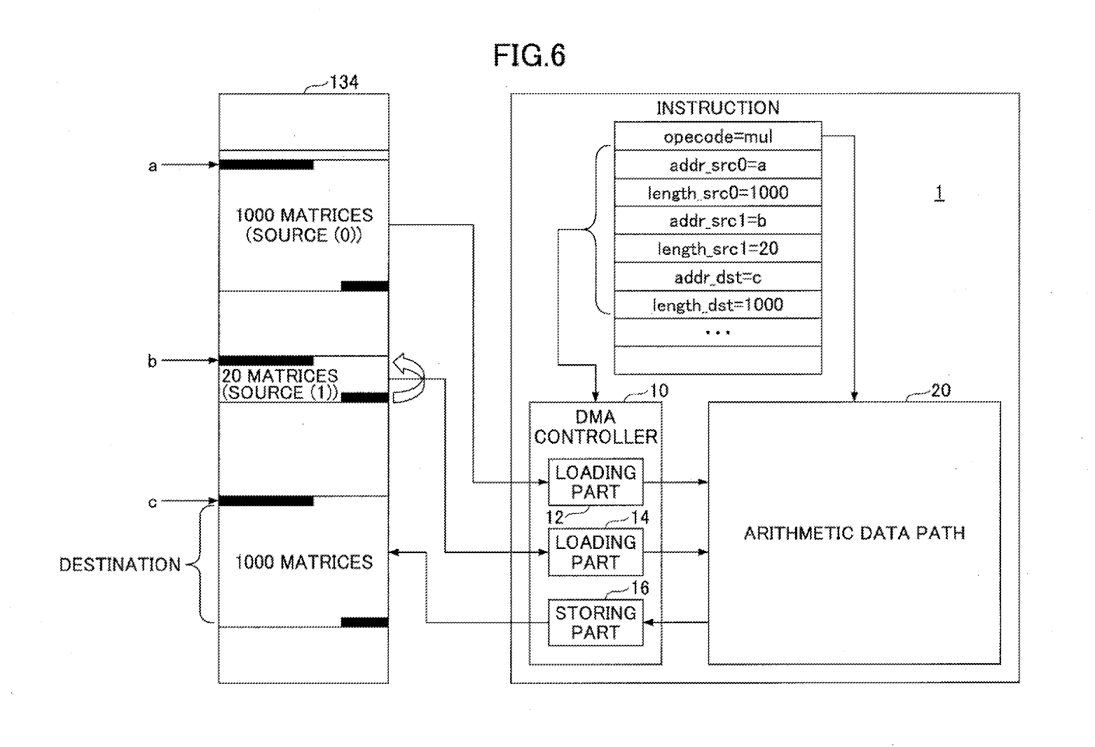

Hereinafter, a wrap around performed by the arithmetic processing unit 1 of the embodiment is described. FIG. 6 illustrates processing including the wrap around performed by the arithmetic processing unit of the embodiment. Instructions given to the arithmetic processing unit 1 includes opecode=mul, addr_src0=a, length_src0=1000, addr_src1=b, length_src1=20, addr_dst=c, and length_dst=1000, where wm is omitted. In this case, the arithmetic processing unit 1 repeatedly reads the source (1) in conformity with a recursive rule indicated by wm_src1 because length_src1=20, i.e., the stream length of the source (1) is 20 which is shorter than the stream length of the destination of 1000.

### [Residual Mode]

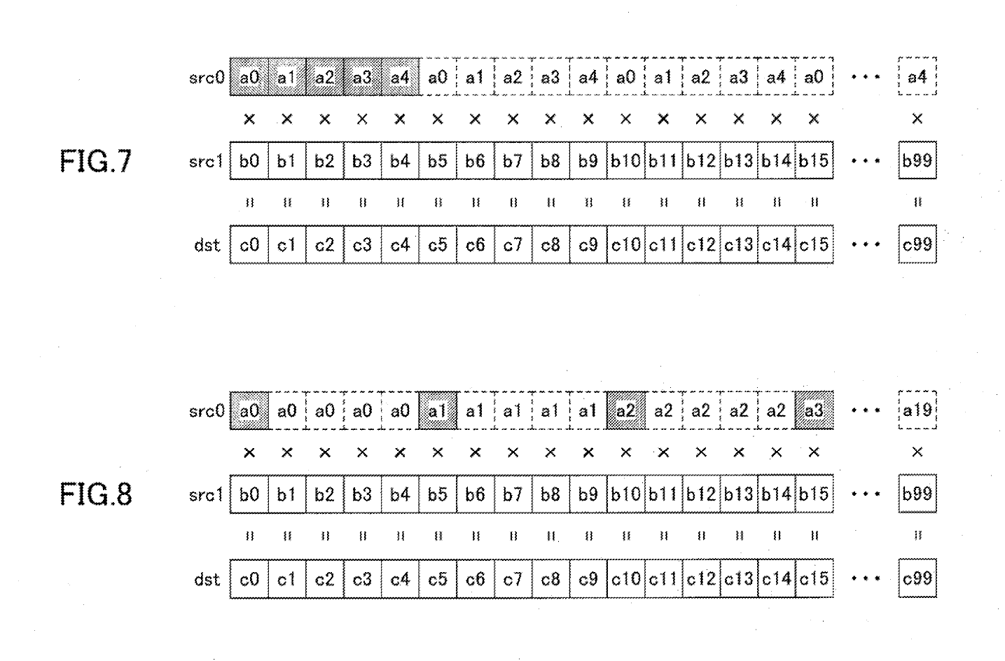

FIG. 7 illustrates processing in a residual mode (wm_src0=1) performed by the arithmetic processing unit 1 of the embodiment. Within FIG. 7, instructions given to the arithmetic processing unit 1 includes opecode=mul, addr_src0=a, length_src0=5, wm_src0=1, addr_src1=b, length_src1=100, wm_src1=0, addr_dst=c, length_dst=100, and wm_dst=0.

In the residual mode, the loading portion 12, in which wm_src0=1 is designated, repeatedly reads the unit of data from a0 after the unit of data are read out of the data memory from a0 to a4 corresponding to the stream length. Specifically, the loading portion 12A reads one of the unit of data stored in the address a indicated by addr_src0 corresponding to the position of a residue number from the beginning of the unit of data stored in the address. Here, the residue number is obtained by dividing a value i input from the cycle counter 18 by length_src0=5. The read one unit of data are stored in the data buffer 12B. In this case, the operation performed by the arithmetic processing unit 1 is expressed by the following formula 1, where “%” designates a residue.

### Formula 1

c[i]=a[i%length_{—}src0]×b[i] (1)

### [Quotient Mode]

FIG. 8 illustrates processing in a quotient mode (wm_src0=2) performed by the arithmetic processing unit 1 of the embodiment. Within FIG. 8, instructions given to the arithmetic processing unit 1 includes opecode=mul, addr_src0=a, length_src0=5, wm_src0=2, addr_src1=b, length_src1=100, wm_src1=0, addr_dst=c, length_dst=100, and wm_dst=0. In the quotient mode, the stream length (length_**) related to a source or destination performing a wrap around does not mean a literal “stream length” but means the denominator in a division.

In the quotient mode, the loading portion 12A to which wm_src0=2 is designated reads the leading unit of data a0 the number of times equal to the stream length. Next, the unit of data a1 are read the number of times equal to the stream length. Thus, the next unit of data are read every time after reading the unit of data the number of times equal to the stream length. Specifically, the loading portion 12A reads one of the unit of data stored in the address a indicated by the addr_src0 corresponding to the position of a quotient from the beginning of the unit of data stored in the address. Here, the quotient is obtained by dividing a value i input from the cycle counter 18 by length_src0=5. The read one unit of data are stored in the data buffer 12B. In this case, the operation performed by the arithmetic processing unit 1 is expressed by the following formula 2, where “/” designates an integer division.

### Formula 2

c[i]=a[i/length_{—}src0]×b[i] (2)

[Exemplary Combinations]

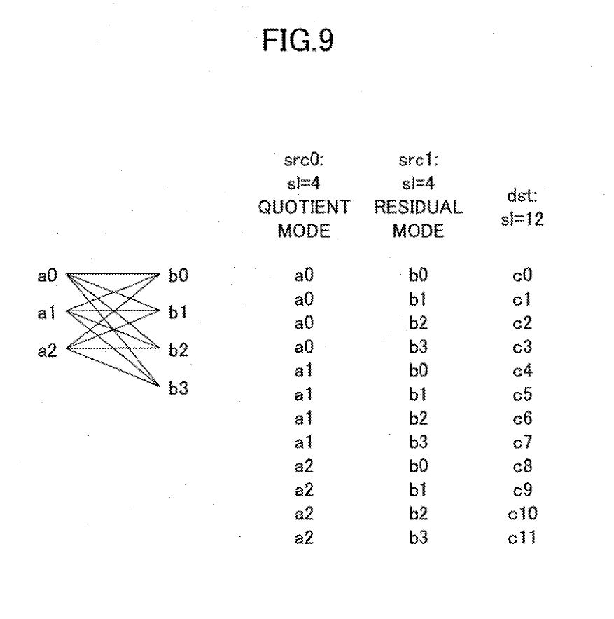

It is possible to combine the residual mode and the quotient mode. FIG. 9 illustrates processing in a quotient mode (wm_src0=2) and a residual mode (wm_src1=1) performed by the arithmetic processing unit 1 of the embodiment. As to the source (0), after a0 is read 4 times equal to the stream length, a1 is read. Every time after reading the unit of data four times, the next unit of data are read. As to the source (1), after b0 to b4, of which total number corresponds to the stream length, are read from the data memory 134, the unit of data are repeatedly read from b0 again.

This wrap around can be performed in the destination. In this case, if length_src0=100, length_src1=100, length_dst=50, and wm_dst=0, after first 50 pieces (the anterior half) of 100 pieces of the results of the operations are stored in the destination, second 50 pieces (the posterior half) are overwritten in place of the destination.

### GENERAL OVERVIEW

When the instruction including wm=1 or wm=2 is input, the arithmetic processing unit 1 of the embodiment 1 reads the source from the data memory 134 in conformity with the recursive rule indicated by the instruction and operates the read source. Therefore, even if stream lengths do not match, a recursive process can be performed by a single instruction.

As a result, the arithmetic processing unit 1 can reduce the processing overhead and enhance the processing speed in comparison with another processing unit in which recursive processes are performed by plural instructions.

Further, when array data (stream data) in a memory is processed, an ordinary scalar processor accesses data having a stream length counting from the initial address. Therefore, a buffer overrun may occur. The buffer overrun may become a software bug which can be scarcely found. Meanwhile, in the arithmetic processing unit 1, since hardware such as the DMA controller 10 treats the initial address and the stream length together, it is possible to prevent a bug from occurring.

In the above, the part of the instruction given to the arithmetic processing unit 1 is given via the address register file 50. However, the CPU 135 may directly designate the address of the data memory 134 and the stream length.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An arithmetic processing unit that performs processing of a stream-type, the arithmetic processing unit comprising:
an arithmetic unit configured to operate an input operand to obtain a result of operation; and
a data input and output unit configured to read the input operand out of a memory when an instruction which is issued in a case where a stream length of the input operand is shorter than a stream length of an output operand corresponding to the input operand and includes data indicating a recursive rule used when the input operand is read out, to supply the read input operand, and to store the result of the operation obtained by the arithmetic unit in the memory as the output operand,
wherein the arithmetic unit operates the input operand read out by the data input and output unit and outputs the result of operation to the data input and output unit.

2. The arithmetic processing unit according to claim 1,
wherein the recursive rule causes to repeat reading the input operand by a time equal to the stream length from a head of the input operand and returning to the head of the input operand.

3. The arithmetic processing unit according to claim 1,
wherein the recursive rule causes to read one data of the input operand by a time equal to the stream length and thereafter to move to one data of a next input operand.

4. An arithmetic processing unit that performs processing of a stream-type, the arithmetic processing unit comprising:
an arithmetic unit configured to operate an input operand to obtain a result of operation; and
a data input and output unit configured to read the input operand out of a memory when an instruction which is issued in a case where a stream length of the output operand corresponding to the input operand is shorter than a stream length of an input operand and includes data indicating a recursive rule used when the output operand is stored in the memory, to supply the read input operand, and to store the result of the operation obtained by the arithmetic unit in the memory as the output operand,
wherein the arithmetic unit operates the input operand read out by the data input and output unit and outputs the result of operation to the data input and output unit.
